(19) United States
(12) Patent Application Publication
(10) Pub. No.: US 2025/0260180 A1
(43) Pub. Date: Aug. 14, 2025

(54) COMPACT THREE-DIMENSIONAL ULTRA-WIDEBAND ANTENNA WITH IMPROVED CIRCULAR POLARIZATION PURITY

(71) Applicant: NovAtel Inc., Calgary (CA)

(72) Inventors: Kevin Chan, Calgary (CA); Mounir Adjrad, Calgary (CA)

(21) Appl. No.: 18/437,337

(22) Filed: Feb. 9, 2024

(51) Int. Cl. H01Q 21/24; H01Q 1/36; H01Q 1/48; H01Q 21/00

(52) U.S. Cl. CPC H01Q 21/24; H01Q 1/36; H01Q 1/48; H01Q 21/0093

(57) ABSTRACT

A compact three-dimensional ultra-wideband antenna that provides improved circular polarization purity is provided. Short-circuited stubs located on a base are connected at the base of one or more radiators. The stubs and radiators are encased in a dielectric material. In an alternative embodiment, a pair of curved radiators extend from the base and are encased in a dielectric. Embodiments generate a quasi-traveling wave along the radiators.

### BACKGROUND

Navigation systems, such as well-known global navigation satellite systems (GNSS) or terrestrial based navigation systems (TNS), typically utilize one or more radio frequency bands for transmission of navigation signals. In many applications, it is desirous for an antenna that is to be utilized with a navigation system receiver to be capable of receiving radio frequencies on a plurality of bands. By enabling such multi-band operation, the navigation system may be utilized with one or more differing GNSS constellations and/or terrestrial navigation systems.

Additionally, it may be desirous for an antenna to have an ultra-wideband range to enable reception of signals outside of conventional GNSS/TNS bands. One example is Xona Space Systems and their proposed Pulsar technology aiming at broadcasting navigation signals in L-band and C-band. Satellite navigation systems employ circular polarization to mitigate unpredictable Faraday rotation that occurs in the ionosphere for linearly polarized radiation. Ultra-wideband, i.e., those having a fractional bandwidth ≥20%, circularly polarized radiation antenna structures are commonly multi-feed or traveling wave. For multi-feed circularly polarized antennas, there is a requirement to separate the feed points to reduce mutual couplings between the points to yield the desired wider bandwidth. However, this separation compromises the size factor.

Compact size is often a necessary and/or desired feature of an antenna for use with navigation systems. Conventionally, stacked patch antennas or helical antennas have been utilized to achieve the necessary bandwidth without requiring a plurality of antennas. However, these types of antennas may not be as compact as required for particular applications. Furthermore, these designs are typically more sensitive to manufacturing tolerances and often require post assembly tuning. Wideband designs are normally not as compact as narrower band antennas as size and bandwidth are normally proportionally related. A compact wideband antenna is a very desirable feature but is challenging to achieve. Additionally, the manufacturing of these conventional antennas may not be economical, nor may they utilize the latest in manufacturing technologies.

Conventional antennas that utilize a travelling wave structure, such as the well-known Vivaldi antenna, typically have a well-defined phase center over an ultra-wide bandwidth. Further, they have a limited dispersion that yields minimal group delay variations over spatial distribution and frequencies. These features may be observable as controlled phase center offsets (PCO) and phase center variations (PCV) where, e.g., the PCO and PCVs are within 5 mm. Tighter PCOs and PCVs translated to higher precision positions for navigation systems, which is desirous for safety critical applications such as autonomous transportation.

### SUMMARY

The above and other disadvantages are overcome by providing a compact three-dimensional ultra-wideband antenna that provides improved circular polarization purity in accordance with illustrative embodiments of the present invention. The antenna structures described herein illustratively generate a quasi-traveling wave and cover an ultra-wideband range. A three-dimensional structure enables the optimal use of volume to achieve wideband radiation through field configuration in the medium.

In accordance with an illustrative embodiment of the present invention, a set of radiators are arranged extending upward from the top of a base. Illustratively, the base is a printed circuit board, which enables ease of integration of the antenna into a larger system or sub-assembly. Each radiator has a short-circuited stub connected thereto along the base. The short-circuited stubs act as secondary radiators for improving bandwidth and circular polarization purity while preserving compactness. Illustratively, this is achieved by multi-resonance and forcing wave direction (“wave torquing”) without the need to add additional volume to the antenna. A conventional feed circuit may be utilized at feed points located on the bottom of the base to connect to each of the radiators. The feed points are illustratively separated to reduce mutual coupling, thereby improving the antenna's bandwidth performance.

The radiators and stubs are encased in a dielectric material. When encased in a dielectric material with a high relative permittivity, the overall antenna size may be reduced, thereby promoting compactness.

In another illustrative embodiment of the present invention, a pair of three-dimensional curved radiators extend up from the top of a base. The radiators are encased in a dielectric and are fed from the bottom of the base. The three-dimensional curved radiators enable wave torquing in a dielectric medium for wideband circular polarization radiation. The curved radiators maximize the use of the volume of the antenna, while the use of a dielectric encasement helps to make the antenna compact.

The dielectric may be a solid, a fluid, such as a gas or liquid, a gel, a paste, or a combination thereof. The dielectric material may be chosen based on a variety of factors including, e.g., permittivity, operating temperature range, size considerations, etc.

### BRIEF DESCRIPTION OF THE DRAWINGS

The above and further advantages of the present invention are described below in conjunction with the accompanying drawings in which like numbers indicate identical or functionally similar elements, of which:

FIG. 1A is a perspective view of an exemplary antenna in accordance with an illustrative embodiment of the present invention;

FIG. 1B is a perspective view of an exemplary antenna in accordance with an illustrative embodiment of the present invention;

FIG. 2 is a perspective bottom view of an exemplary antenna in accordance with an illustrative embodiment of the present invention;

FIG. 3 is a perspective view of an exemplary antenna in accordance with an illustrative embodiment of the present invention;

FIG. 4 is a perspective view of an exemplary fluid filled antenna in accordance with an illustrative embodiment of the present invention;

FIG. 5 is a perspective view of an exemplary fluid filled antenna in accordance with an illustrative embodiment of the present invention;

FIG. 6 is a chart detailing simulated and measured results of an antenna built in accordance with an illustrative embodiment of the present invention;

FIG. 7A is a graph illustrating realized gain of an antenna built in accordance with an illustrative embodiment of the present invention;

FIG. 7B is a graph illustrating realized gain of a conventional antenna;

FIG. 8 is a graph showing measured return loss of an antenna built in accordance with an illustrative embodiment of the present invention; and

FIG. 9 is a graph showing the axial ratio of an antenna built in accordance with an illustrative embodiment of the present invention.

### DETAILED DESCRIPTION OF AN ILLUSTRATIVE EMBODIMENT

Embodiments of the present disclosure are directed to a compact antenna that is inspired from the well-known Vivaldi design. Illustrative embodiments described herein utilize a wave torquing technique to improve polarization purity for either right-hand circularly polarized (RHCP) or left-hand circularly polarized (LHCP) antennas. The antenna structure illustratively generates a quasi-traveling wave and covers an ultra-wideband range. In accordance with an illustrative embodiment described herein, the bandwidth covers approximately 1.16-1.6265 GHz, which covers the GPS L1-L5 bands as well as the Xona's Pulsar signal frequencies. As will be appreciated by those skilled in the art, by changing dimensions utilized, the antenna may be modified to cover alternative bandwidths. Therefore, the description of a particular set of ranges of frequencies covered by an illustrative embodiment of the antenna should be taken as exemplary only.

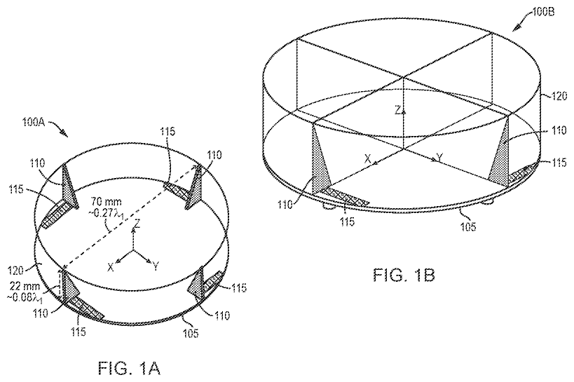

FIG. 1A is a perspective view of an exemplary antenna 100A in accordance with an illustrative embodiment of the present invention. The antenna 100A illustratively comprises of a base 105 onto which the other components are layered. Base 105 is illustratively shown as circular, but in accordance with illustrative embodiments of the present invention, may have any shape. Therefore, the depiction of a circular base 105 should be taken as exemplary only.

Illustratively, base 105 serves to define an imaginary X-Y plane that will be used to describe the location of other elements of the antenna. However, it should be noted that base 105 does not need to be flat. Therefore, the depiction of base 105 as being flat should be taken as exemplary only. As used herein, the top of base 105 is the side wherein radiating elements, described below, are disposed, while the bottom of the base is the opposite side. Similarly, the axis extending away from the top side of the base shall be referred to as the positive Z-axis herein.

A set of radiators 110 are arranged around the base 105 and extend upwards from the base. Each radiator has a predefined shape, e.g., an equation based exponential taper, a right-angled triangle, etc. Illustratively, the radiators have a height that is sub-wavelength from the lowest operating frequency of the antenna. This three-dimensional profile of the illustrative antenna creates a quasi-traveling wave structure that provides enhanced bandwidth performance. In an illustrative embodiment, the radiators 110 are arranged equidistant around the base; however, in alternative embodiments they may be arranged in non-equidistant locations, such as that shown and described below in reference to FIG. 1B.

Each radiator 110 has an associated stub 115 that lies on the base 105 and is operatively interconnected with the radiator. Illustratively, the stubs are short circuited; however, in alternative embodiments they may not be short-circuited. Therefore, the description of short-circuited stubs should be taken as exemplary only and to also include non-short-circuited stubs.

The short-circuited stubs act as secondary radiators and work to improve circular polarization purity and bandwidth of the antenna. The short-circuited stubs enable wave torquing to improve the circular polarization purity. As used herein the term wave torquing means generally providing wave guidance in a desired direction. The stubs are illustratively shown in a position that is counterclockwise (when viewed from above the top side of the base). In this configuration, right hand circular polarization is improved. If they are located on the clockwise side of radiator 110, left hand circular polarization will be improved.

The radiators and short-circuited stubs may be made of any conductive material. In accordance with an illustrative embodiment, they are made of copper. However, it is expressly contemplated that other materials may be utilized. Therefore, the description of copper being used should be taken as exemplary only.

In accordance with an illustrative embodiment of the invention, the radiators 110, short-circuited stubs 115, and top of the base 105 are encased in a dielectric material 120. Dielectric material 120 illustratively extends from the top of base 105 to the top of radiators 110. In an illustrative embodiment, the dielectric material 120 has a permittivity greater than 2. The use of dielectric materials with higher permittivity allows the antenna to be reduced in size, but with a lowered gain.

Further, in accordance with illustrative embodiments, the dielectric material may comprise a solid, a fluid (liquid, gas, or gel), or a hybrid combination thereof. In an illustrative embodiment of the present invention, dielectric material 120 is ceramic. By utilizing certain materials as a dielectric, the antenna may be additively manufactured by the use of, for example, 3D printers. One example of such a material is ceramic infused thermoplastic. This capability of being additively manufactured works to reduce the overall cost, and ease-of-use and ease of manufacture of antennas as described herein. The description of any particular construction technique and/or material should be taken as exemplary only.

FIG. 1B is a perspective view of an exemplary antenna 100B in accordance with an illustrative embodiment of the present invention. Exemplary antenna 100B is similar in design to antenna 100A. However, only two radiators 110 and short-circuited stubs 115 are provided. As can be seen from antenna 100B, the radiators and associated short-circuited stubs are not arranged equidistant around the edge of the base 105. In this illustrative embodiment, the radiation pattern will be skewed as compared to antenna 100A and will have a lower gain. In this exemplary embodiment, the phase angle between the two feed points will be 90°. While antenna 100B is shown and described with two radiators that are offset 90°, the principles of the present invention may be utilized with other offsets. Therefore, the description of two radiators offset by 90° should be taken as exemplary only.

In accordance with alternative embodiments of the present invention, any number of radiators/short-circuited stub pairings may be utilized. Therefore, the depiction of antenna 100A having four radiators and antenna 100B having two radiators should be taken as exemplary only. Additionally, it should be noted that antenna 100A may be converted to antenna 100B by adjusting the feed network to only operate two of the radiators. This may occur due to an intentional decision or as the result of a failure of the feed network, damage to the antenna, etc. In this way, an antenna built in accordance with embodiments of the present invention may provide additional functionality and/or redundancy.

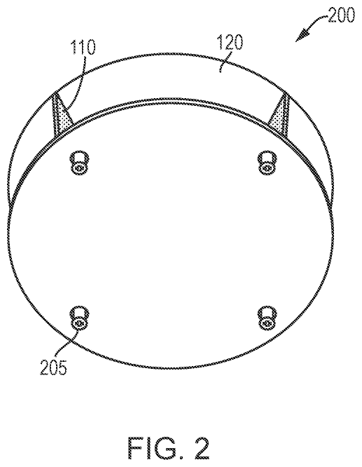

FIG. 2 is a perspective view 200 of a bottom side of an exemplary antenna in accordance with an illustrative embodiment of the present invention. As can be seen from exemplary view 200, feed points 205 are aligned beneath each of the radiators 110 of the antenna 100A. They are further placed a distance away from the geometric middle point of the base 105 X-Y plane to enable impedance matching and reduced mutual coupling among the ports. Illustratively, these feed points 205 are implemented as 50 Ohm coaxial feed points. However, it should be noted that in alternative embodiments of the present invention, differing types of feeds may be utilized. Therefore, the description 50 Ohm coaxial feeds should be taken as exemplary only.

In operation, a conventional quad feed circuit (not shown) is operatively connected to feed points 205 to provide the necessary phase differenced feeding to provide circular polarization.

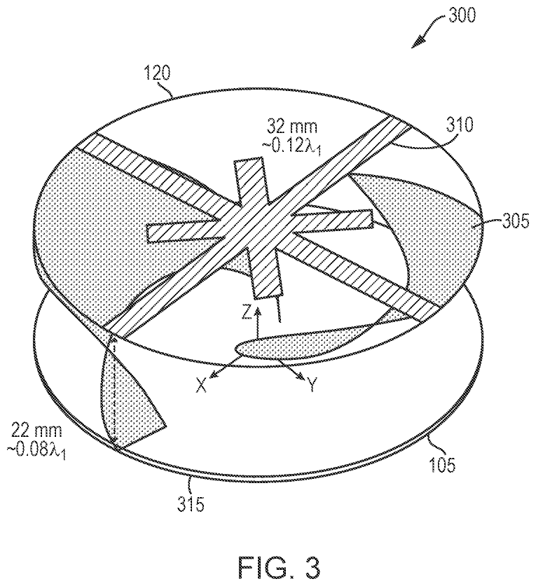

FIG. 3 is a perspective view of an exemplary antenna 300 in accordance with an illustrative embodiment of the present invention. In exemplary antenna 300, the radiators 110 have been replaced by curved radiating elements 305. These curved radiating elements 305 are arranged to create wave torquing to improve circular polarity in accordance with an illustrative embodiment of the present invention. As noted above, the term wave torquing means generally providing wave guide in a desired direction as the wave propagates along a radiation (longitudinal) direction, setting up a quasi-traveling wave in the structure. This three-dimensional arrangement sets up the radiation fields with an optimized use of volume to yield a wideband circularly polarized radiation in a compact space.

Illustratively, the curved radiating elements 305 are equation-based exponential tapers that originate from their corresponding feed points located on the base 105 and taper exponentially away, at their inner edges, from the geometric central point of the base. This tapering occurs in the positive Z axis while its tapering inner-edges, where the radiation fields are set up, undergo a rotation to cause the antenna to have circularly polarized radiation. Should the rotation be clockwise (when viewed from above the antenna), the antenna will be left hand circularly polarized. Conversely, should the rotation be counterclockwise, the antenna will be right hand circularly polarized.

In an illustrative embodiment, the amount of rotation of the inner edges of the curved radiating elements along the Z-axis is dependent on the electrical length of the waveguiding structure, i.e., the curved radiator. The rotation angle at any point of the inner edge corresponds to the instantaneous phase angle with respect to the guided wave's target frequency of operation. Illustratively, the feed point is utilized as the signal phase origin for reference.

The curved radiating element's surface that extends from the inner edge towards the circumferential edge of the dielectric material encasing the radiators undergoes a rotation of twice the angular rate of rotation of the inner edge at any point along the Z-axis. To choke (phase) the return currents, to improve the antenna's bandwidth, the curved radiating elements each have a section removed at the edges contacting the top side of the base 105. Illustratively, the section that is removed is a half torus. Illustratively, the half torus is centered along the Z-axis with an outside radius that is less than the base. This allows the radiating elements to be in contact with the base.

A pair of crossed arms 310 may be located on top of the dielectric material to enhance polarization purity. The crossed arms 310 also causes the structure to act as a loop-dipolar structure that helps in impedance matching for a higher bandwidth. Illustratively, the crossed arms 310 may be made of the same material as radiators. In alternative embodiments, the crossed arms may be made of a differing material.

Illustratively, the side edge of base 105 has side plating 315 to provide a current path continuity from the outer edges of radiators 305 to the ground plane of base 105.

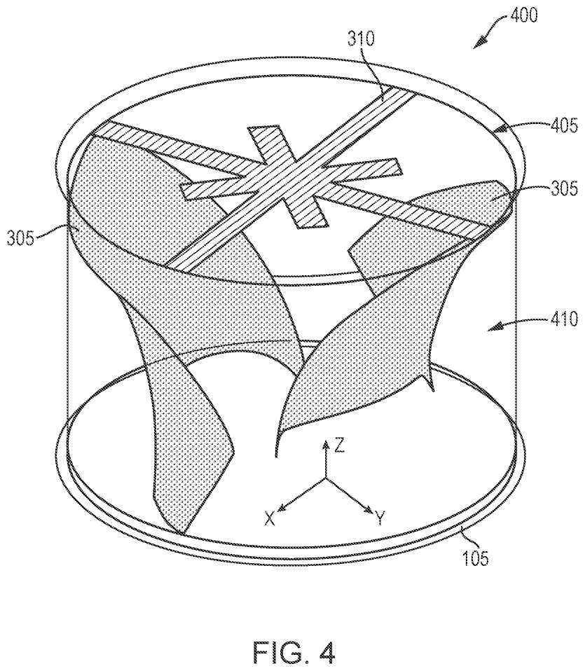

FIG. 4 is an exemplary perspective view of an exemplary antenna 400 in accordance with an illustrative embodiment of the present invention. Antenna 400 is of a similar configuration as antenna 300 but utilizes a fluid dielectric 410. To accommodate the fluid dielectric 410, an outer shell 405 is required to contain the fluid. Outer shell 405 may be made of a dielectric, such as a plastic casing. The use of a plastic casing should be taken as exemplary only.

The fluid, which may be a liquid, gas, gel, paste, or combination thereof, may vary depending on the operating environment of the antenna. For example, a liquid may be utilized in environments where there is not a chance of the liquid freezing, while a gas may be used in alternative embodiments where extremely low temperatures are expected. A reference liquid dielectric is water. However, water freezes at a relatively high temperature, i.e., zero degrees Celsius. A mixture of water and alcohol may be utilized in environments where the temperature may be significantly below zero degrees Celsius.

The material of the fluid dielectric may be dielectric itself or may be conductive and then be mixed with suitable materials to create a desired permittivity. For example, solutes could be added to water (or another liquid) to create a desired dielectric. Examples of solutes that may be utilized with water include, e.g., Sodium Chloride (NaCl).

In alternative embodiments of the present invention, ionic liquids may be utilized as fluid dielectric. One exemplary ionic liquid that may be utilized is choline L-alanine; however, other ionic liquids may be utilized in alternative embodiments. Therefore, the description of choline L-alanine should be taken as exemplary only.

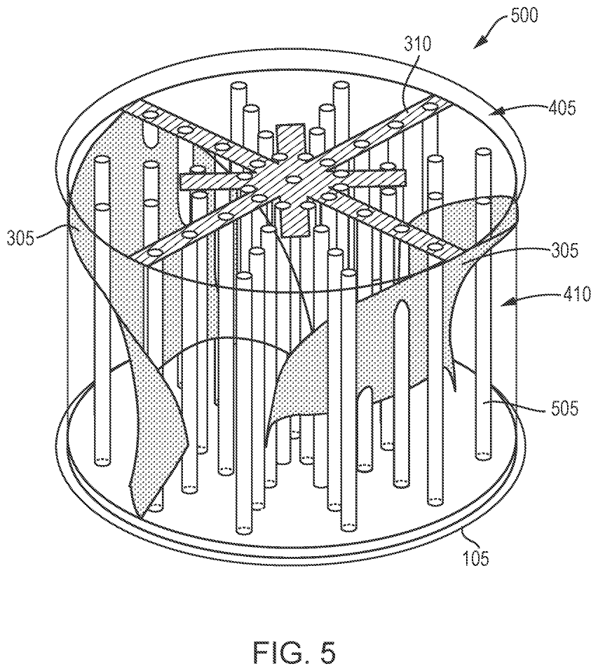

FIG. 5 is a perspective view of an exemplary antenna 500 in accordance with an illustrative embodiment of the present invention. Exemplary antenna 500 is of a similar configuration as antenna 400 but utilizes a hybrid dielectric. That is, a fluid dielectric 410 is utilized in conjunction with dielectric rods 505. Dielectric rods 505 may be made of ceramic or any other material that has the desired dielectric properties, such as graphene oxide. The description of ceramic and graphene oxide being used as the dielectric rods 505 should be taken as exemplary.

By combining both a fluid dielectric 410 and dielectric rods 505, the desired permittivity of the combined (hybrid) dielectric may be obtained. In accordance with an illustrative embodiment, customized permittivity values may be obtained by adjusting the mixture ratio of one or more fluid dielectrics 410. It should be noted that while circular rods are shown, in accordance with alternative embodiments of the present invention other shapes may be utilized. Therefore, the depiction of circularly shaped dielectric rods 505 should be taken as exemplary only. Further, while FIG. 5 depicts the dielectric rods 505 extending from the base to the same height as the radiators, in alternative embodiments, they may have differing heights.

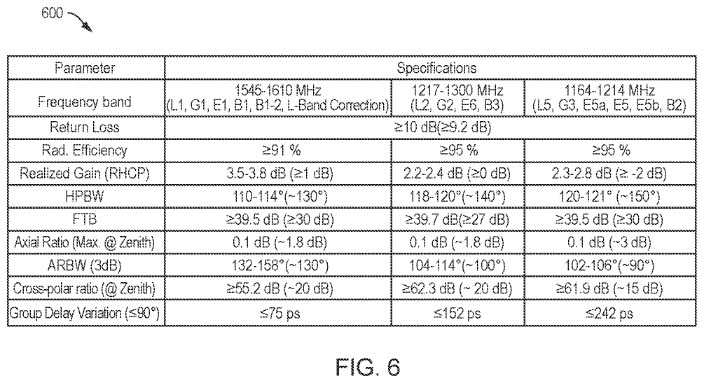

FIG. 6 is a chart 600 detailing simulated and measured specifications for an antenna constructed in accordance with the principles of the present invention. These specifications are for an antenna constructed in accordance with the embodiment shown and described in connection with FIG. 1. The constructed antenna had a diameter of 69.2 mm±0.4 mm and a height of 20.95 mm±0.1 mm and utilized PREPERM® ABS1000, as the dielectric. The radiators were 0.08 times the wavelength of the lowest frequency. Using the selected dielectric material, the antenna was additively manufactured by use of a 3-D printer. The constructed antenna weighed 176.4 grams.

The values in parentheses in the chart are the measured values and the other values were those generated via simulation. As can be seen from the measured results, the exemplary antenna achieves the desired goal of providing ultra-wide bandwidth in a compact form factor.

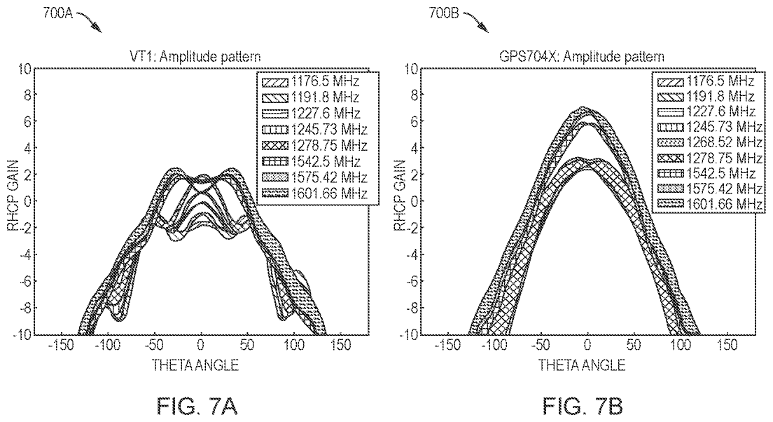

FIGS. 7A-B show the realized gain from the antenna constructed according to the principles of the present invention 700A and the gain from using a conventional GPS-704-X antenna 700B, available from NovAtel, Inc. of Calgary, Alberta, Canada. The GPS-704-X antenna has a diameter of 185 mm, a height of 69 mm, and a weight of 468 grams, which is substantially larger than the antenna built in accordance with an illustrative embodiment of the present invention.

As can be seen from charts 700A and 700B, the novel antenna of the present invention compares favorably in realized gain to a conventional antenna. These charts also highlight the stability of the radiation patterns as compared to the GPS-704-X antenna over azimuth angles. It has a very wide bandwidth and a very compact size. Further, as it may be additively manufactured, total costs may be lower as compared to a conventionally made antenna.

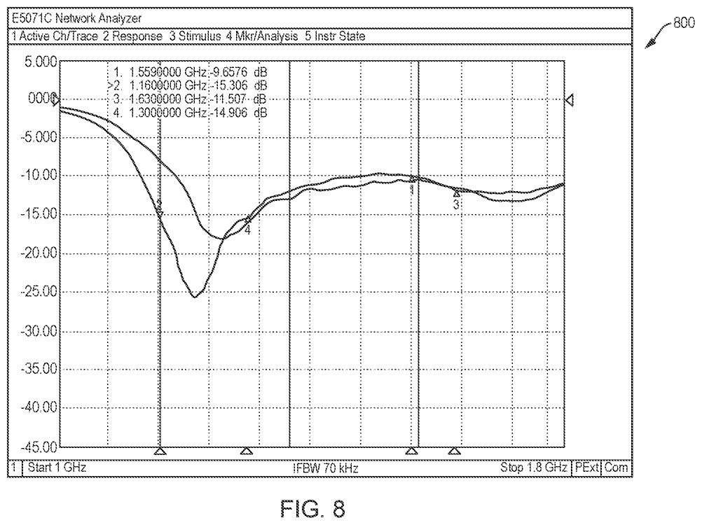

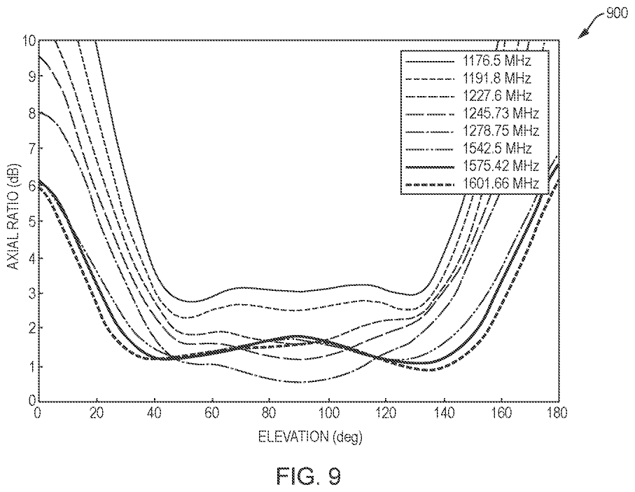

FIG. 8 is a graph illustrating the measured return loss of an antenna built in accordance with an illustrative embodiment of the present invention. FIG. 9 is a graph illustrating measured axial ratio of an antenna built in accordance with an illustrative embodiment of the present invention. As can be seen from FIGS. 8 and 9, antennas constructed in accordance with embodiments of the present invention have excellent broadband circularly polarized performance.

While the present invention has been shown and described using various dimensions, radio frequency bandwidths, materials, shapes, number of radiating elements, etc., it should be noted that the principles of the present invention may be utilized in differing configurations. Therefore, the description contained herein should be taken as exemplary only.

What is claimed is:

1. An antenna comprising:
a base with a first side and a second side, the base having a first shape and a geometric central point;
a set of N radiators on the first side of the base, the N radiators lying in a plane substantially perpendicular to the base are arranged in a rotation manner about the geometric central point, wherein each of the N radiators has a second shape;
wherein each of the N radiators has a stub attached thereto along the first side of the base, the stubs acting as secondary radiators for improving circular polarization purity and the bandwidth of the antenna;
wherein the N radiators and the stubs are encased in a dielectric material; and
a set of N feed points having, each of the N feed points having a first electrical connection connected to one of the set of N radiators, spaced at a distance away from the geometric central point, with each of the N feed points having a second electrical connection connected to the second side of the base, wherein each of the N feed points has a difference in phase of its input signal relative to an adjacent feed point's input signal, the difference in phase being an angle to the adjacent radiator for generating circularly polarized radiation.

2. The antenna of claim 1 wherein the stubs are short-circuited.

3. The antenna of claim 1 wherein the first shape and a parallel cross-section of the dielectric material encasing the N radiators and the stubs are identical.

4. The antenna of claim 3 wherein the first shape and the dielectric material have their extents containing fully the radiators and stubs.

5. The antenna of claim 1 wherein the second shapes are equation-based exponential tapers originating from a predefined point on the base and tapering exponentially away from the geometric central point towards straight edges along the planes substantially perpendicular to the base.

6. The antenna of claim 5 wherein a height of the second shapes is a sub-wavelength with respect to a lowest frequency of operation.

7. The antenna of claim 1 wherein the dielectric has a relative permittivity of greater than two.

8. The antenna of claim 7 wherein the dielectric material is a ceramic.

9. The antenna of claim 8 wherein the ceramic is a variant capable of being additively manufactured.

10. The antenna of claim 9 wherein the ceramic is a ceramic infused thermoplastic.

11. The antenna of claim 7 wherein the dielectric material is a fluid substrate contained in a dielectric shell.

12. The antenna of claim 11 wherein the fluid substrate is dielectric.

13. The antenna of claim 11 wherein the fluid substrate is partially conductive.

14. The antenna of claim 11 wherein the fluid substrate has solutes dissolved in the liquid to alter its electrical properties.

15. The antenna of claim 7 wherein the dielectric material is a combination of one or more solid substrates and one or more liquid substrates.

16. The antenna of claim 1 wherein the stubs are arranged in a clockwise direction of each of the N radiators to cause the antenna to have improved left hand circular polarization purity and bandwidth.

17. The antenna of claim 1 wherein the stubs are arranged in a counterclockwise direction of each of the N radiators to cause the antenna to have improved right hand circular polarization purity and bandwidth.

18. The antenna of claim 1 wherein the second side of the base is metalized to act as a ground plane.

19. The antenna of claim 1 wherein the N radiators create a quasi-traveling wave, having sub-wavelength, with respect to a lowest frequency of operation, dimension along an axis perpendicular to the top side of the base.

20. The antenna of claim 1 wherein the antenna has a fractional bandwidth of at least 20%, thereby qualifying the antenna as ultra-wideband.

21. The antenna of claim 1 wherein the dielectric and N radiators are additively manufactured.

22. The antenna of claim 1 wherein extents of the base and a cross-section of the dielectric material encasing the N radiators and the stubs are within sub-wavelength with respect to a lowest frequency of operation.

23. An antenna comprising:
a circular base having a top side and a bottom side and a geometric central point;
two or more radiators contacting top side traces of the base, wherein the radiators have a first shape, the first shape being a three-dimensional structure extending from the top side surface of the base, each radiator of first shape arranged in a sequential rotation manner about the geometric central point at an angle of 180° apart for a pair;
wherein the two or more radiators create a quasi-traveling wave and circularly polarized radiation through wave guiding;
wherein the two or more radiators and the top side of the base are encased in a dielectric material having a top side; and
two or more feed points having first electrical connections connected to the two or more radiators at the top side traces of the base, separate from the geometric central point for improved bandwidth, with second electrical connections connected to the bottom side of the base, wherein each of the feed points has a phase difference of its input signal to its other feed point's input signal of 180° for a pair, and sequentially rotated phases for more radiators.

24. The antenna of claim 23 wherein the base has side plating to provide continuity of current from the edges of the radiators to the bottom side of the base.

25. The antenna of claim 23 wherein the height of the first shapes, and a height of the dielectric material encasing the radiators, are a sub-wavelength with respect to a lowest frequency of operation.

26. The antenna of claim 23 wherein the dielectric material has a relative permittivity of greater than two.

27. The antenna of claim 23 wherein the dielectric material is a ceramic.

28. The antenna of claim 27 wherein the ceramic is a variant that can be additively manufactured.

29. The antenna of claim 28 wherein the ceramic is a ceramic infused thermoplastic.

30. The antenna of claim 23 wherein the second side of the base is metalized to act as a ground plane.

31. The antenna of claim 23 wherein the antenna has a fractional bandwidth of at least 20% thereby qualifying the antenna as ultra-wideband.

32. The antenna of claim 23 wherein the dielectric and radiating shapes are additively manufactured.

33. The antenna of claim 23 wherein the dielectric material is a fluid substrate contained in a dielectric shell.

34. The antenna of claim 33 wherein the fluid substrate is dielectric.

35. The antenna of claim 33 wherein the fluid substrate is partially conductive.

36. The antenna of claim 33 wherein the fluid substrate has solutes dissolved in the liquid to alter its electrical properties.

37. The antenna of claim 33 wherein the dielectric material is a combination of one or more solid substrates and one or more liquid substrates.

38. The antenna of claim 23 wherein a diameter of the circular base and a cross-section of the dielectric material encasing the radiators are within a sub-wavelength with respect to a lowest frequency of operation

39. The antenna of claim 23 further comprising a widened cross metallic trace connecting ends of the two or more radiators is located on the top surface of the dielectric material encasing the radiators and top side of the base.

40. The antenna of claim 23 wherein the first shapes are equation-based exponential tapers originating from the corresponding feed points and tapering exponentially away, at inner edges, from the geometric central point along a longitudinal direction while its tapering inner-edges, where the radiation fields are setup, undergo a clockwise rotation to cause the antenna to have left hand circularly polarized radiation;
wherein the amount of rotation of the inner-edges along the longitudinal direction is dependent on the electrical length of the radiator, where the rotation angle at any point of the inner-edge corresponds to the instantaneous phase angle with respect to a guided wave's target frequency of operation referencing from the feed point as the signal phase origin;
wherein the surface extending from the inner edge of a first shape towards the circumferential edge of the dielectric material encasing the radiators undergo a clockwise rotation of twice the angular rate of rotation of the inner-edge at any point along the longitudinal direction;
wherein the rotating surfaces of the first shapes has a section removed at the edges contacting the top side of the base, where the section of the surfaces removed constitute a half torus, for the purpose of phasing the return currents to improve the bandwidth.

41. The antenna of claim 23 wherein the first shapes are equation-based exponential tapers originating from the corresponding feed points and tapering exponentially away, at the inner edges, from the geometric central point along the longitudinal direction while its tapering inner-edges, where the radiation fields are setup, undergo a counterclockwise rotation to cause the antenna to have right hand circularly polarized radiation;
wherein the amount of rotation of the inner-edges along the longitudinal direction is dependent on the electrical length of the waveguiding structure, where the rotation angle at any point of the inner-edge corresponds to the instantaneous phase angle with respect to a guided wave's target frequency of operation referencing from the feed point as the signal phase origin;
wherein the surface extending from the inner edge of a first shape towards the circumferential edge of the dielectric material encasing the radiators undergo a counterclockwise rotation of twice the angular rate of rotation of the inner edge at any point along the longitudinal direction;
wherein the rotating surfaces of the first shapes has a section removed at the edges contacting the top side of the base, where the section of the surfaces removed constitute a half torus, for the purpose of phasing the return currents to improve the bandwidth.
